(19) United States
(12) Patent Application Publication
(10) Pub. No.: US 2007/0169705 A1
(43) Pub. Date: Jul. 26, 2007

(54) Cover for bird feeder

(76) Inventor: Paul Cote, Knowlton (CA)

Correspondence Address: Eric Fincham, 316 Knowlton Road, Lac Brome, QC, J0E 1V0, CA

(21) Appl. No.: 11/399,211

(22) Filed: Apr. 6, 2006

(30) Foreign Application Priority Data
Jan. 20, 2006 (CA) 2,533,482

(51) Int. Cl. A01K 61/02

(52) U.S. Cl. 119/52.3

(57) ABSTRACT

A cover for a selective type bird feeder, the cover having at least one downwardly extending wall with a protrusion formed on an inwardly facing surface of the downwardly extending wall and a side wall of a shroud or feed tube having a keyway to permit entry of the protrusion, and a biasing member to bias the cover upwardly. The cover arrangement provides for easy removal and replacement while permitting access to the inside of the feed tube.

### FIELD OF THE INVENTION

The present invention relates to bird feeders and more particularly, relates to selective bird feeders.

### BACKGROUND OF THE INVENTION

Selective bird feeders are well known in the art and they are designed to limit the maximum size of a bird or animal which can access the seeds in the feeder. There are many reasons for excluding certain birds and animals including the fact that for many people, certain bird species may be regarded as undesirable. Many people only wish to have smaller birds present at the feeder and not many of the larger birds. Thus, some of the larger birds such as crows, grackles, blue jays, and the like are considered by a segment of the population to be undesirable.

A further problem associated with bird feeders is that some of the larger birds and animals which gain access to the seeds can devour a large quantity thereof in a relatively short period of time. Again, for many people, this is considered to be undesirable as the cost of maintaining the feeder full exceeds the capability of the person to purchase the seeds. Furthermore, many of these larger birds and animals can create quite a mess as they often tend to merely throw the seeds on the ground.

One animal in particular which many people consider undesirable is the squirrel. However, the squirrels are well known for their ability to overcome most of the devices designed to prevent them from reaching the seeds.

In order to overcome these problems, many feeders have a mechanism which renders them more or less squirrel proof. Generally, these arrangements utilize a movable shroud which moves into and out of a position whereby the seed can be accessed. Typically, such bird feeders utilize an arrangement wherein one of the shroud or seed tube is biased by a spring such that when a larger weight lands on the shroud, the shroud moves relative to the seed tube.

An important component of such squirrel proof bird feeders is the cover member which must be designed to cooperate with the moveable shroud while also permitting ready access to the seed tube for filling of the same.

### SUMMARY OF THE INVENTION

It is an object of the present invention to provide a cover arrangement suitable for use with a squirrel proof bird feeder and which cover arrangement provides for secure locking of the same while permitting easy removal thereof.

According to one aspect of the present invention there is provided a squirrel proof bird feeder having a feed tube and a shroud surrounding at least a portion of the feed tube, and a cover, the improvement comprising an arrangement wherein the cover has at least one downwardly extending wall, a protrusion formed on an inwardly facing surface of the downwardly extending wall, a side wall of at least one of the feed tube and shroud having a key way to permit entry of the protrusion, the key way having a vertical entry way, a horizontal portion, and an upper recessed portion and the bird feeder having biasing means to bias the cover upwardly.

According to the present invention, the cover may be attached to either the feed tube or the shroud or alternatively, to a member seated on top of one of the seed tube or shroud. A locking arrangement between the cover and the seed tube/shroud is provided which biases the cover into a locking arrangement.

As previously discussed, the key way includes an entry, a lead in portion, and an upper recessed portion. The lead in permits the protrusion on the cover to pass downwardly as the cover is placed in position. Thus, the entry is preferably vertical or in a generally vertical position though a diagonally extending entry could also be employed.

The recessed portion maintains the protrusion in position to effectively lock the cover to a body portion of the bird feeder.

Extending between the entry and the recessed portion is a lead in portion. This lead in portion may be generally horizontal though, as will be understood by those knowledgeable in the art, the lead in portion may extend somewhat diagonally. Indeed, the entry and the lead in portions may be combined into a single entity extending diagonally within the wall and this arrangement is considered equivalent to the disclosed embodiment.

The key way may be formed in the feed tube, in the shroud, or in a separate member which is attached to either the shroud or feed tube. A preferred embodiment comprises a collar sitting on top of the shroud and secured thereto. The collar can have an inner and outer wall, with the outer wall having a pair of key ways formed therein as will be described in the embodiment illustrated in the drawings.

The biasing means are effective to exert an upward pressure on the cover when it is in the locked position. Conveniently, a plurality of biasing members may be employed with each biasing member having a shaft enclosed in a recess with a coil spring extending thereabout. The coil spring will exert an upward pressure on a head portion of the biasing member.

In an alternative embodiment, the biasing member may exert a biasing force on the bird feeders which have a centrally located post interiorly of the feed container.

In a further aspect of the present invention, there is provided an arrangement wherein the cover is secured by means of biasing members extending outwardly and which have a protrusion designed to engage with a recess formed in a side wall of the cover. In this arrangement, a simple inward pressure on one or more of the members permits the removal of the cover.

### BRIEF DESCRIPTION OF THE DRAWINGS

Having thus generally described the invention, reference will be made to the accompanying drawings illustrating embodiments thereof, in which:

Figure is a sectional view of a cover arrangement for a bird feeder according to one embodiment of the present invention;

FIG. 2 is a perspective view of collar portion of the embodiment of FIG. 1;

FIG. 3 is a cross sectional view of the cover and collar illustrating the biassing of the cover;

FIG. 4 is an exploded view of a cover and collar according to a further embodiment of the present invention;

FIG. 5 is view similar to FIG. 2 with a portion of the collar being cut away;

FIG. 6 is cross sectional view through the upper portion of a bird feeder having the cover and collar of FIGS. 4 and 5;

FIG. 7 is an exploded view of a further embodiment of the present invention;

FIG. 8 is an exploded view of a variation of the embodiment of FIG. 7;

FIG. 9 is a further variation of the embodiment of FIG. 7; and

FIG. 10 is an exploded view of a still further variation thereof.

### DETAILED DESCRIPTION OF THE INVENTION

Referring to the drawings in greater detail and by reference characters thereto, there is illustrated in FIGS. 1 to 3 a first embodiment of the present invention which will now be described.

As may be seen in FIG. 1, there is provided a cover generally designated by reference numeral 10 along with a ring or collar generally designated by reference numeral 12.

Cover 10 includes an upper dome portion 14 which has a centrally located aperture 16 therein through which a cable or other hanging means may extend. Dome portion 14 merges, at its lower end, with a concave arcuate transition portion 18 which in turn merges with a horizontal portion 20. At its outer extremity, horizontal portion 20 merges with a convex arcuate transition portion 22 which leads to a substantially vertical side wall 24. From side wall 24, there is provided a further concave arcuate transition portion 36 and which terminates in a drip edge 28. As will be noted, there are provided a plurality of dimples or projections 30 on side wall 24.

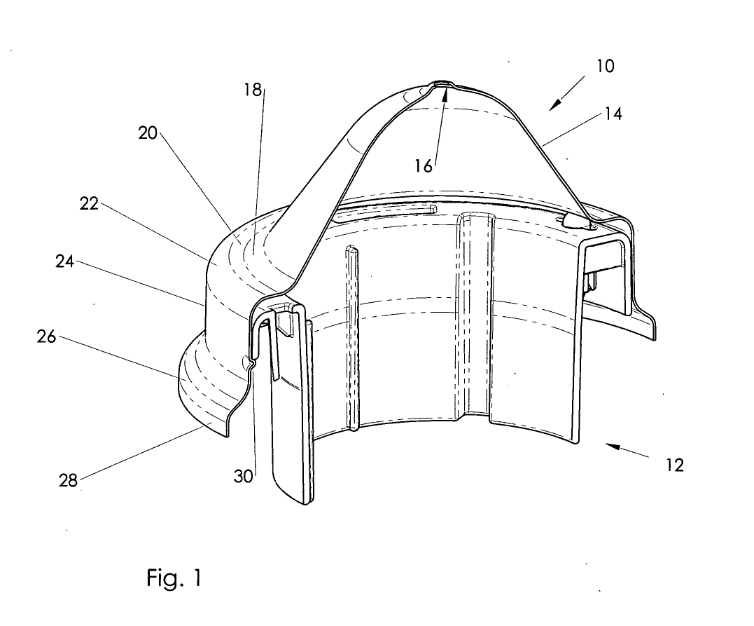

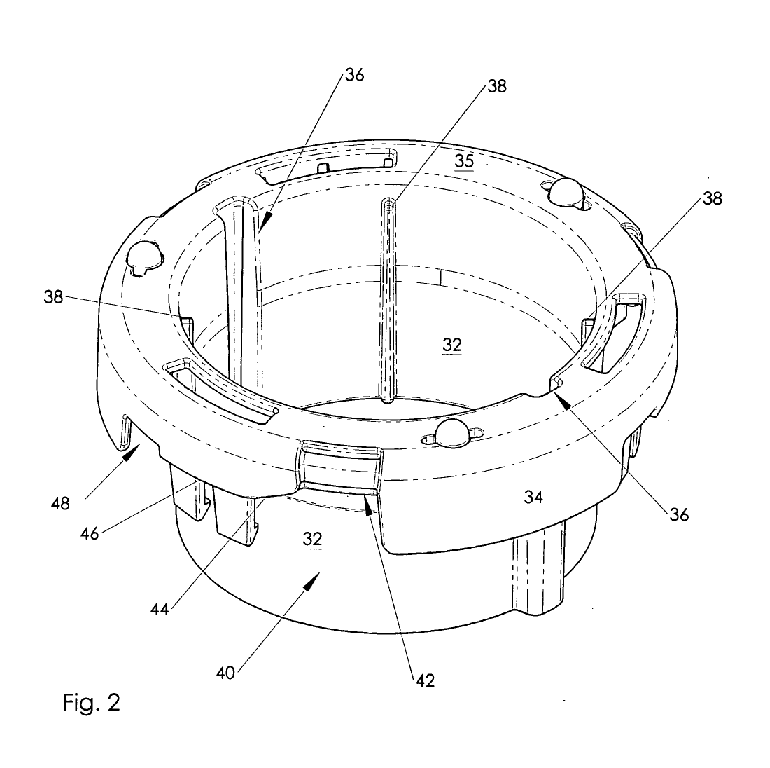

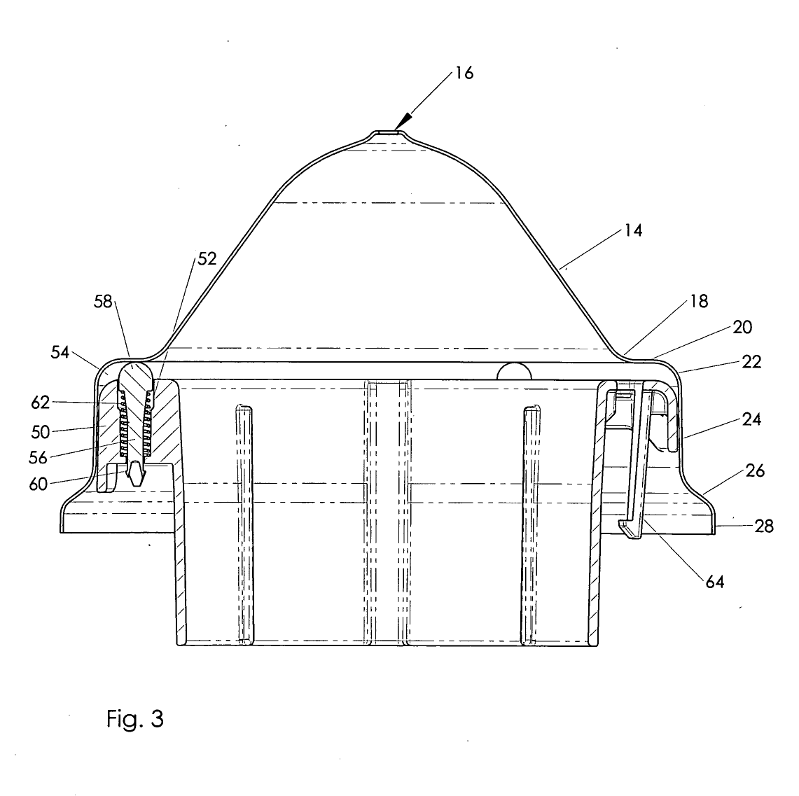

Collar 12 is best illustrated in FIGS. 2 and 3 and reference will now be had thereto. Collar 12 includes an inner side wall 32, an outer side wall 34, and a top wall 35 extending between inner side wall 32 and outer side wall 34. On the interiorly facing surface of inner side wall 32, there are provided a pair of vertical recesses 36 for reasons which are best set forth in co-pending U.S. patent application Ser. No. filed in the name of Paul Cote contemporaneously with the present application. Similarly, there are provided a plurality of centering ribs 38 for a feed tube (not shown). In outer side wall 34, there is provided a key way generally designated by reference numeral 40 and which includes an entry way 42, a first ramped portion 44 formed on the lower marginal edge of inner side wall 32, a horizontal edge 46, and a recess portion 48. Thus, key way 40 is designed to receive a dimple or protrusion 30 and as the cover is placed in position, dimple or protrusion 30 will slide along ramped portion 44 and horizontal portion 46 of the lower marginal edge of inner side wall 32 to seat within recess portion 48.

As best seen in FIG. 3, in intermediate inner side wall 32 and outer side wall 34 there are provided solid portions or sections 50 which have an interior recess 52. A biasing member 54 fits within recess 52 and includes a stem 56, an enlarged head 58, and a lower stop portion 60. Extending about stem 56 is a coil spring 62. Thus, the biasing member 54 is urged upwardly to seat against horizontal section 20 of cover 10 and urge the same to maintain a locked position wherein dimple 30 is seated within recess portion 48.

A plurality of attaching hooks 64 are provided for securing collar 12 to a shroud.

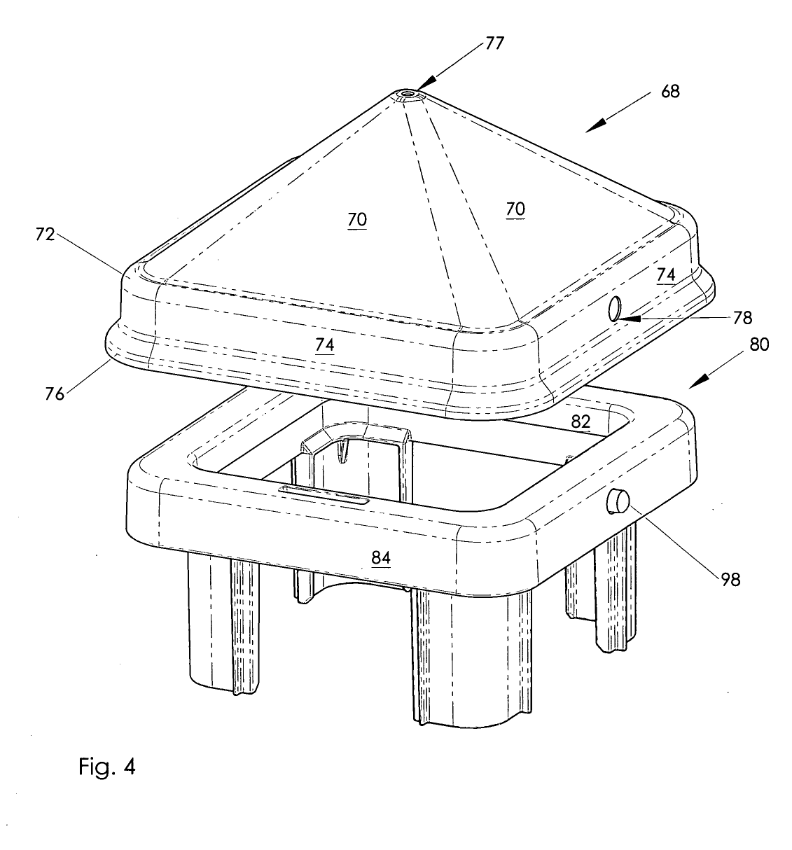

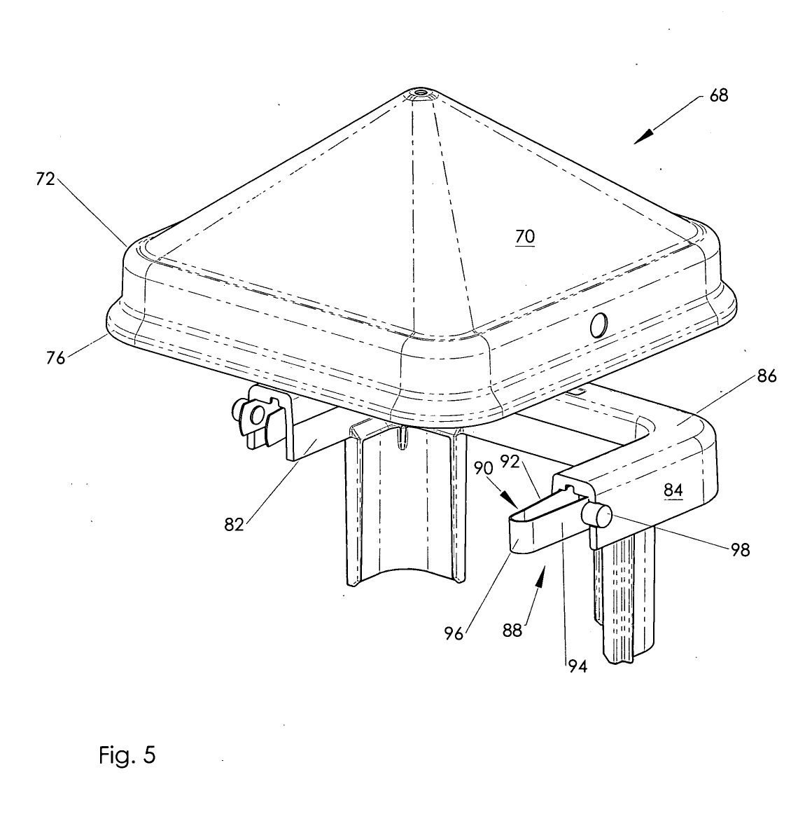

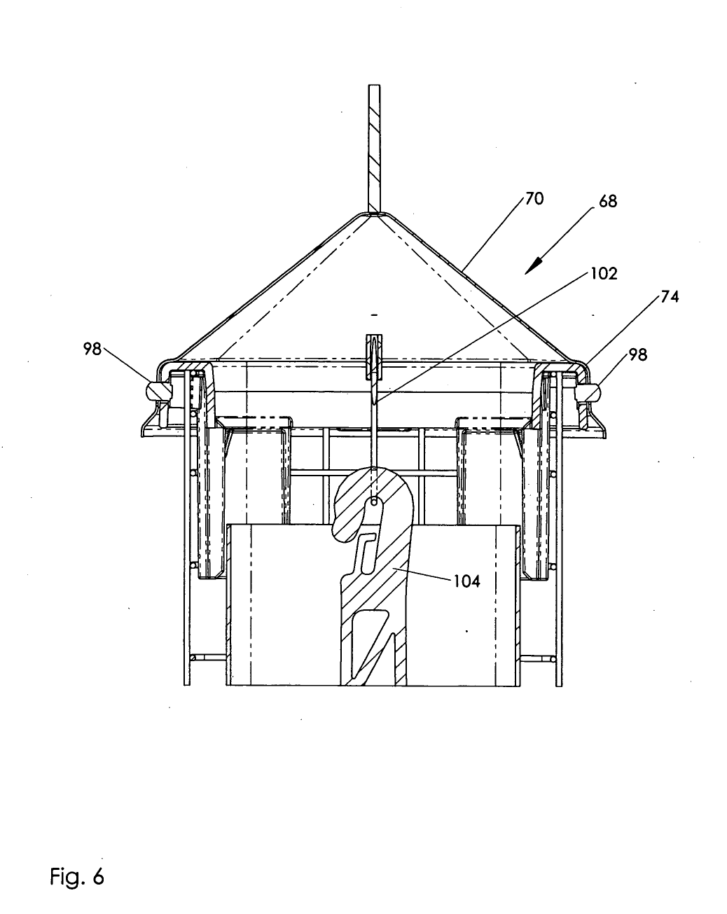

Turning to the embodiment of FIGS. 4 to 6, there is illustrated therein a cover 68 and a collar generally designated by reference numeral 80.

Collar 68 includes a plurality of sloped panels 70 each having a concave arcuate transition portion 72 which merges with a substantially vertical side wall 74. At the end of side wall 74, there is provided a drip edge 76.

Located centrally of sloped panels 70 is an aperture 77 through which a cable or hanging member may pass. As will be seen in the drawings, there are provided apertures 78 in two of the side wall panels 74.

Collar 80 includes an inner wall 82, an outer wall 84 and a top wall 86 extending between inner wall 82 and outer wall 84. Also mounted between inner wall 82 and outer wall 84 is a biasing means generally designated by reference numeral 88.

Biasing means 88 comprises a U-shaped resilient member 90 having first and second legs 92, 94 joined together by a bight 96. On second leg 94, at one end thereof, there is provided a button 98 which is sized to fit within an aperture 78 in side wall 74 of cover 68.

The bird feeder will include a shroud as is shown in co-pending U.S. patent application Ser. No. filed in the name of Paul Cote contemporaneously with the present application. A cable 102 is provided for hanging the feeder which is attached to an inner post 104.

Thus, as may be seen, by depressing the button 98, the cover is free to be removed and access may be had to an interior feed tube.

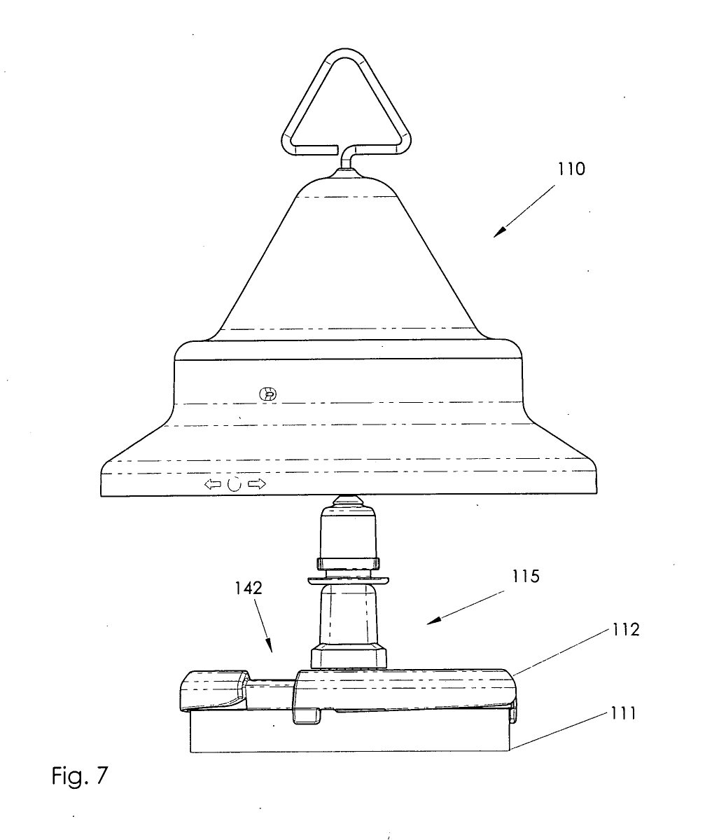

An alternative embodiment is illustrated in FIG. 7 wherein reference numerals in the hundreds. are employed. In this arrangement, there is provided a cover 110 which seats within a key way 142 formed in collar 112. However, in this instance, cover 112 is placed on a feed tube 111. A biasing arrangement 115 which will be described in greater detail hereinbelow is provided.

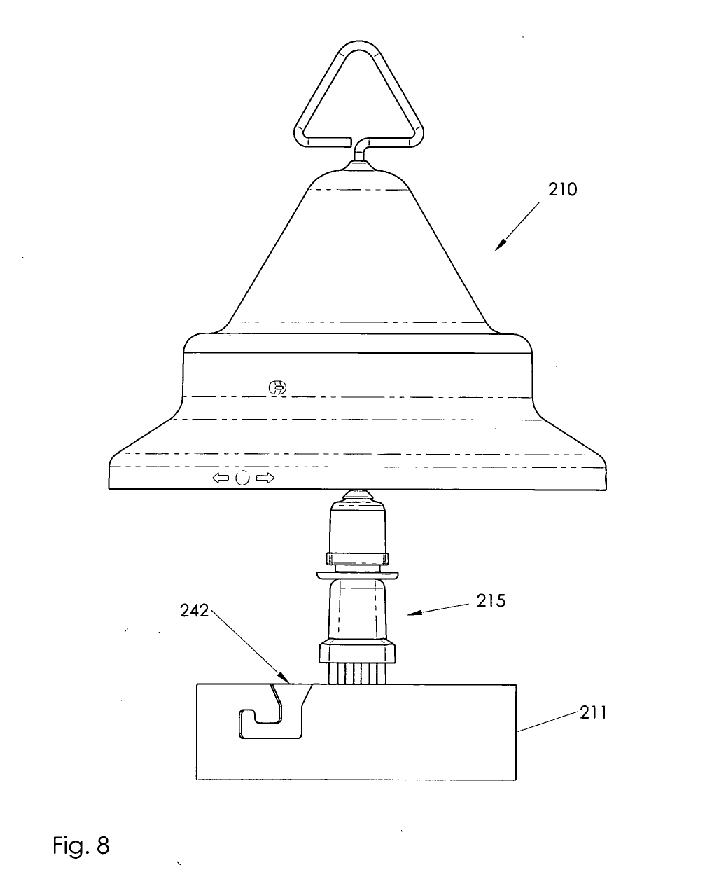

In the embodiment of FIG. 8, a cover 210 is designed to fit directly on a seed tube 211 which has a key way 242 formed therein. Again, a central biasing means 215 is provided.

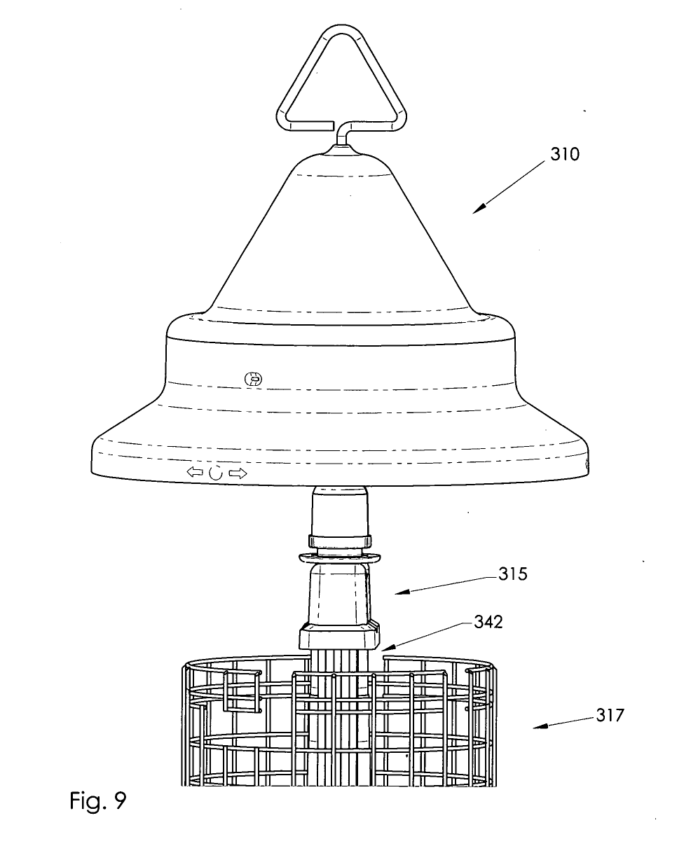

In the embodiment of FIG. 9, a cover 310 is designed to seat directly on a shroud 317 having key way 342 therein. Again, a central biasing means 315 is provided.

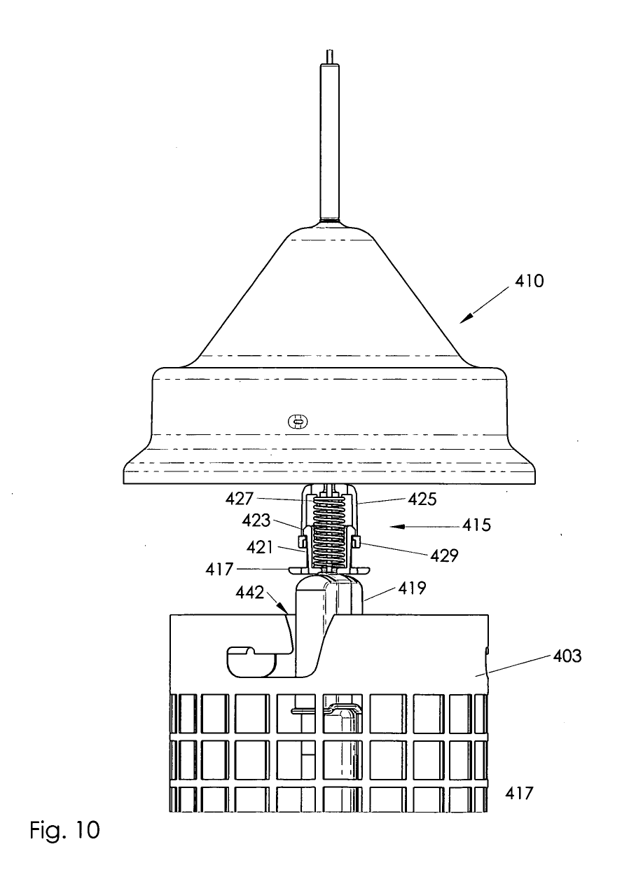

In FIG. 10, a cover 410 is designed to seat directly on a shroud 417. In this embodiment, shroud 417 has a solid upper portion 403 which has a key way 442 formed therein.

Biasing means 415 includes a lower housing having a base 417 which is designed to sit on cover 419 which covers a central tube in the bird feeder. Extending upwardly from base 417 is a wall 421 which has an enlarged portion 423 at a distal end thereof. An upper housing 425 also has, at its lower end, inwardly extending flanges 429 while interiorly of wall 421, there is provided a biasing spring 427 which will push the upper housing 425 upwardly to seat against the upper portion of cover 410.

It will be understood that the above described embodiment is for purposes of illustration only and changes and modifications may be made thereto without departing from the spirit and scope of the invention.

I claim:

1. In a squirrel proof bird feeder having a feed tube and a shroud surrounding at least a portion of said feed tube, and a cover, the improvement wherein:
said cover comprises an upper portion, at least one downwardly extending wall from said upper portion, a protrusion formed on an inwardly facing surface of said downwardly extending wall;
a side wall of one of said feed tube and shroud having a key way to permit entry of said protrusion, said key way having a generally vertical entry, a lead in portion, and an upper recessed portion; and
said bird feeder having biasing means to bias said cover upwardly.

2. The squirrel proof bird feeder of claim 1 wherein said key way is formed in an upper side wall portion of said shroud.

3. The bird feeder of claim 1 wherein said key way is formed in an upper wall portion of said feed tube.

4. The bird feeder of claim 1 wherein said bird feeder includes a collar on an upper wall portion of said shroud, said key way being formed in said collar.

5. The bird feeder of claim 1 wherein said bird feeder includes a collar on an upper portion of said feed tube, said key way being formed in said collar.

6. The bird feeder of claim 1 wherein said biasing means comprise a plurality of spring biased members formed in a collar of said bird feeder, said biasing members exerting an upward pressure on said cover.

7. The bird feeder of claim 1 wherein said biasing means includes a spring biased member mounted on a central post of said bird feeder, said center post being located inwardly of said feed container, said biasing member exerting an upward pressure on said cover.
